(19) United States
(12) Patent Application Publication
(10) Pub. No.: US 2025/0333088 A1
(43) Pub. Date: Oct. 30, 2025

(54) Coupling Device

(71) Applicant: ORLANDO HEALTH, INC., Orlando, FL (US)

(72) Inventors: Michael Glen Olson, Belle Isle, FL (US); Anthony Michael Mango, Orlando, FL (US); Michael Schmidt, Maitland, FL (US)

(73) Assignee: ORLANDO HEALTH, INC., Orlando, FL (US)

(21) Appl. No.: 18/651,220

(22) Filed: Apr. 30, 2024

(51) Int. Cl. B62B 3/02; B62B 5/00; F16C 11/06

(52) U.S. Cl. CPC B62B 3/02; B62B 5/00; F16C 11/0619

(57) ABSTRACT

A coupling device, including: an inner shaft; a claw assembly pivotably coupled to the inner shaft; and an outer cap movably coupled to the inner shaft. The outer cap is movable between a proximal position and a distal position. When the outer cap is in the proximal position, the claw assembly is in a first state, and when the outer cap is in the distal position, the claw assembly is in a second state. When the claw assembly is in the first state, the claw assembly is configured to receive a first material within the claw assembly to couple the first material to the coupling device, and when the claw assembly is in the second state, the claw assembly and a distal surface of the outer cap are configured to receive a second material therebetween to couple the second material to the coupling device.

### TECHNICAL FIELD

The present disclosure relates generally to a device/method for coupling at least two materials (e.g., part of two devices) for transport of the at least two materials together.

### BACKGROUND

Carts are used in numerous settings across many different industries, and in healthcare, they are used to transport goods and materials all over the hospital. Oftentimes users are expected to move multiple heavy carts at a single time. Currently this requires a user to stand between them and use one arm to pull and another to push independent carts simultaneously. This is a difficult task and may result in a loss of control leading to an accident that may harm the users or damage whatever they are transporting.

### SUMMARY

One general aspect of the present disclosure includes a coupling device, including: an inner shaft; a claw assembly pivotably coupled to the inner shaft, the claw assembly including at least one claw pivotable around a claw pivot point between a first state and a second state; and an outer cap movably coupled to the inner shaft, where the outer cap is movable between a proximal position and a distal position, where the claw assembly extends distal to the outer cap, where the outer cap is configured such that when the outer cap is in the proximal position, the claw assembly is in the first state, and when the outer cap is in the distal position, the claw assembly is in the second state, where when the claw assembly is in the first state, the claw assembly is configured to receive a first material within the claw assembly to couple the first material to the coupling device, and where when the claw assembly is in the second state, the claw assembly and a distal surface of the outer cap are configured to receive a second material therebetween to couple the second material to the coupling device.

Another general aspect of the present disclosure includes a method of operating a coupling device, the coupling device including an inner shaft, a claw assembly pivotably coupled to the inner shaft, and an outer cap movably coupled to the inner shaft, where the outer cap includes at least one opening, the claw assembly includes at least one button portion, and when the claw assembly is in a closed state, the at least one button portion at least partially extends through the at least one opening, the method including: pressing the at least one button portion inward such that the at least one button portion is moved outside of the at least one opening, such that the outer cap is moved upward by the inner shaft and the claw assembly is moved from the closed state to an open state.

Another general aspect of the present disclosure includes a connector assembly, including: a connector shaft including a socket configured to receive a first part of a ball joint; and an outer connector cap movably coupled to the connector shaft, where the outer connector cap is configured to be movable between a fixed position and a released position, where when the outer connector cap is in the fixed position, the outer connector cap is configured to receive a second part of a ball joint to lock the ball joint within the socket between the outer connector cap and the socket, and where when the outer connector cap is in the released position, the first part of the ball joint can be released from the socket.

Another general aspect of the present disclosure includes a method of operating a connector assembly, the connector assembly including a connector shaft including a socket configured to receive a first part of a ball joint, and an outer connector cap movably coupled to the connector shaft, where the outer connector cap is configured to be movable between a fixed position and a released position, the method including: placing a ball joint in the socket while the outer connector cap is away from the socket; moving the outer connector cap towards the socket and locking the ball joint in the socket between the outer connector cap and the socket; moving the outer connector cap distally away from the socket; and releasing the ball joint from the socket.

A device/method according to the present disclosure may include any combination of the features described above and/or the original as-filed claims.

Other systems, methods, features and advantages of the invention will be, or will become, apparent to one with skill in the art upon examination of the following figures and detailed description. It is intended that all such additional systems, methods, features and advantages be within the scope of the invention.

### BRIEF DESCRIPTION OF DRAWINGS

FIG. 1 is a perspective view of an embodiment of a coupling assembly including a first coupling device and a second coupling device, where the first coupling device is in a closed state and the second coupling device is in an open state, and the second coupling device is coupled to a second material.

FIG. 2 is a perspective view of the first coupling device of FIG. 1, where the first coupling device is in the closed state and is coupled to a first material.

FIG. 3 is a side view of the coupling assembly of FIG. 1, where the first and the second coupling devices are in the closed state.

FIG. 4 is a cross-sectional view of the coupling assembly of FIG. 3.

FIG. 5 is a side view of the coupling assembly of FIG. 1, where the first and the second coupling devices are in the open state.

FIG. 6 is a cross-sectional view of the coupling assembly of FIG. 5.

FIG. 7 is an illustration showing the coupling assembly of FIG. 1 is used to connect two carts together, where the first coupling device is coupled to one cart in the open state, and the second coupling device is coupled to another cart in the open or closed state.

FIG. 8 is a perspective view of an embodiment of an outer cap of a coupling device of the coupling assembly of FIG. 1.

FIG. 9 is another perspective view of the outer cap of FIG. 8.

FIG. 10 is a perspective view of an embodiment of an inner shaft of a coupling device of the coupling assembly of FIG. 1.

FIG. 11 is a cross-sectional view of the inner shaft of FIG. 10.

FIG. 12 is a perspective view of an embodiment of a claw of a coupling device of the coupling assembly of FIG. 1.

FIG. 13 is another perspective view of the claw of FIG. 12.

FIGS. 14 and 15 are perspective views showing the claw of FIG. 12 is coupled to the inner shaft of FIG. 10.

FIG. 16 is a perspective view showing the outer cap of FIG. 8, the claw of FIG. 12, and the inner shaft of FIG. 10 are coupled together with the claw in a closed state.

FIG. 17 is a cross-sectional view showing the assembled outer cap, claw, and inner shaft of FIG. 16.

FIGS. 18 and 19 are illustrations of the method of opening the second coupling device of FIG. 1 to couple the second coupling device to the second material when the second coupling device is in the open state.

FIGS. 20 and 21 are perspective views showing the outer cap of FIG. 8, the claw of FIG. 12, and the inner shaft of FIG. 10 are coupled together with the claw in an open state.

FIG. 22 is a cross-sectional view showing the assembled outer cap, claw, and inner shaft of FIGS. 20 and 21.

FIG. 23 is a perspective view of an embodiment of an outer connector cap of a connector assembly.

FIG. 24 is a perspective view of an embodiment of a connector shaft of a connector assembly.

FIGS. 25-27 are perspective views of an embodiment of a connector assembly including the outer connector cap of FIG. 23 and the connector shaft of FIG. 24, showing the method of moving the outer connector cap from a fixed position to a released position.

FIGS. 28-30 are perspective views showing a method of connecting a ball joint of the inner shaft of FIG. 10 with the connector assembly of FIG. 25, where the ball joint is received in a socket of the connector shaft of FIG. 24 and locked in the socket by the outer connector cap of FIG. 23.

FIG. 31 is a perspective view of the assembled inner shaft and the connector assembly of FIG. 30, showing the inner shaft is pivotable relative to the connector assembly via the ball joint.

FIG. 32 is an illustration showing the coupling assembly of FIG. 1 is used to connect a plurality of carts together, allowing the plurality of carts to move together while along a curved path.

FIGS. 33-35 are cross-sectional views showing the process of moving the first coupling device of FIG. 4 from a closed state to an open state.

FIGS. 36-38 are cross-sectional views showing the process of moving the first coupling device of FIG. 6 from an open state to a closed state.

### DETAILED DESCRIPTION

Various embodiments are described below with reference to the drawings in which like elements generally are referred to by like numerals. The relationship and functioning of the various elements of the embodiments may better be understood by reference to the following detailed description. However, embodiments are not limited to those illustrated in the drawings. It should be understood that the drawings are not necessarily to scale, and in certain instances details may have been omitted that are not necessary for an understanding of embodiments disclosed herein, such as—for example—conventional fabrication and assembly.

### GENERIC DESCRIPTION

The invention is defined by the claims, may be embodied in many different forms, and should not be construed as limited to the embodiments set forth herein; rather, these embodiments are provided so that this disclosure will be thorough and complete, and will fully convey enabling disclosure to those skilled in the art. As used in this specification and the claims, the singular forms “a,” “an,” and “the” include plural referents unless the context clearly dictates otherwise. Reference herein to any industry standards (e.g., ASTM, ANSI, IEEE standards) is defined as complying with the currently published standards as of the original filing date of this disclosure concerning the units, measurements, and testing criteria communicated by those standards unless expressly otherwise defined herein.

The terms “first,” “second,” and so on, as used herein are not meant to be assigned to a particular component so designated, but rather are simply referring to such components in the numerical order as addressed, meaning that a component designated as “first” may later be a “second” such component, depending on the order in which it is referred. It should also be understood that designation of “first” and “second” does not necessarily mean that the two components or values so designated are different, meaning for example a first coupling device may be the same as a second coupling device, with each simply being applicable to separate but identical components.

The terms “proximal”, “proximally”, “distal”, and “distally” are used herein in the common usage sense where “proximal” and “proximally” refer to a direction towards the center of the coupling assembly or a user, and “distal” and “distally” refer to a direction away from the center of the coupling assembly or a user. The terms “about,” “substantially,” “generally,” and other terms of degree, when used with reference to any volume, dimension, proportion, or other quantitative or qualitative value, are intended to communicate a definite and identifiable value within the standard parameters that would be understood by one of skill in the art (e.g., equivalent to a mechanical engineer with experience in this field), and should be interpreted to include at least any legal equivalents, minor but functionally-insignificant variants, standard manufacturing tolerances, and including at least mathematically significant figures (although not required to be as broad as the largest range thereof), including a variance of up to, for example 5%, 2%, 1%, or less or more as would be deemed appropriate by one of skill in the art. In addition, the term “configured to” is used to describe structural limitations in a particular manner that requires specific construction to accomplish a stated function and/or to interface or interact with another component(s), and is not used to describe mere intended or theoretical uses.

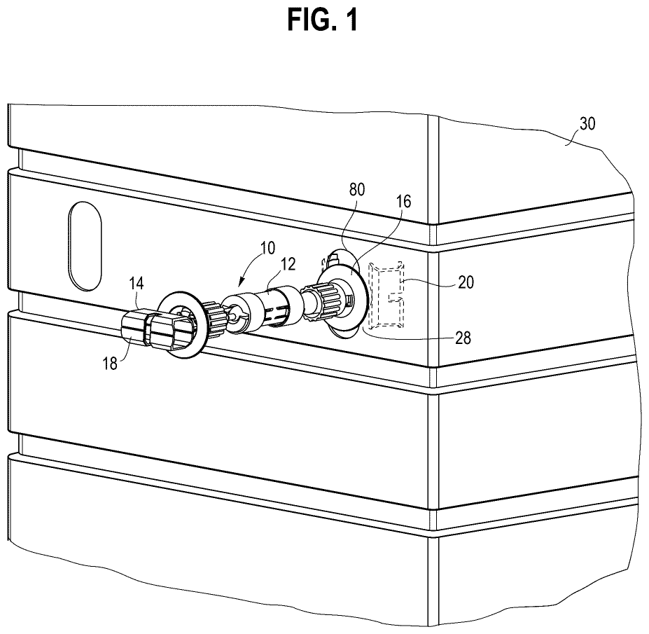

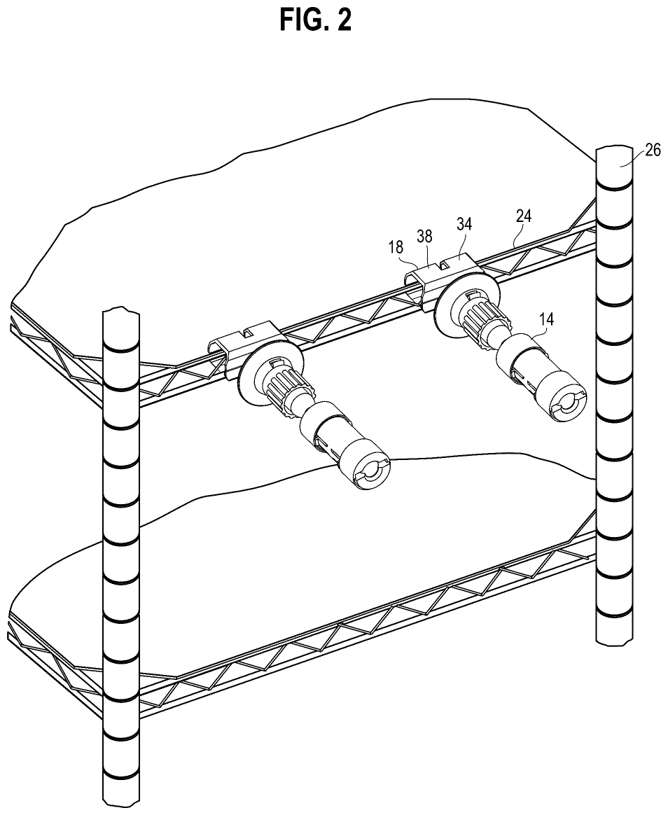

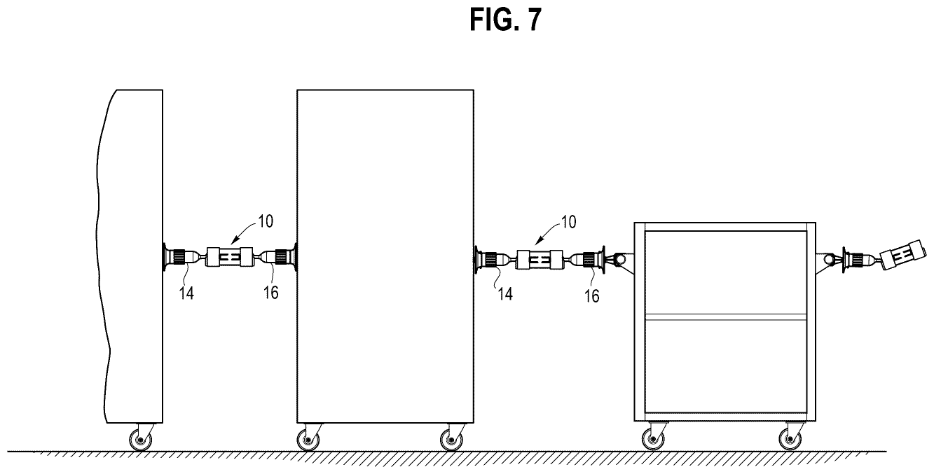

Referring to FIGS. 1-7, a coupling assembly 10 is shown, where the coupling assembly 10 includes a connector assembly 12, a first coupling device 14, and a second coupling device 16. The first and the second coupling devices 14 and 16 are coupled to the opposite two ends of the connector assembly 12. As shown in FIGS. 1 and 2, the first coupling device 14 is in a closed state 18, and the second coupling device 16 is in an open state 20. The first coupling device 14 is configured to couple to a first material 24 of a first device 26 (e.g., a wire shelf, as shown in FIG. 2) in the closed state 18, and the second coupling device 16 is configured to couple to a second material 28 of a second device 30 (e.g., a utility cart/a big tote, as shown in FIG. 1) in the open state 20, as discussed in greater detail below. As shown in FIG. 7, the first and/or the second coupling devices 14 and 16 are configured to connect to the first and/or the second materials 24 and 28 such that the first and/or the second materials 24 and 28 and the first and/or the second coupling devices 14 and 16 can move together.

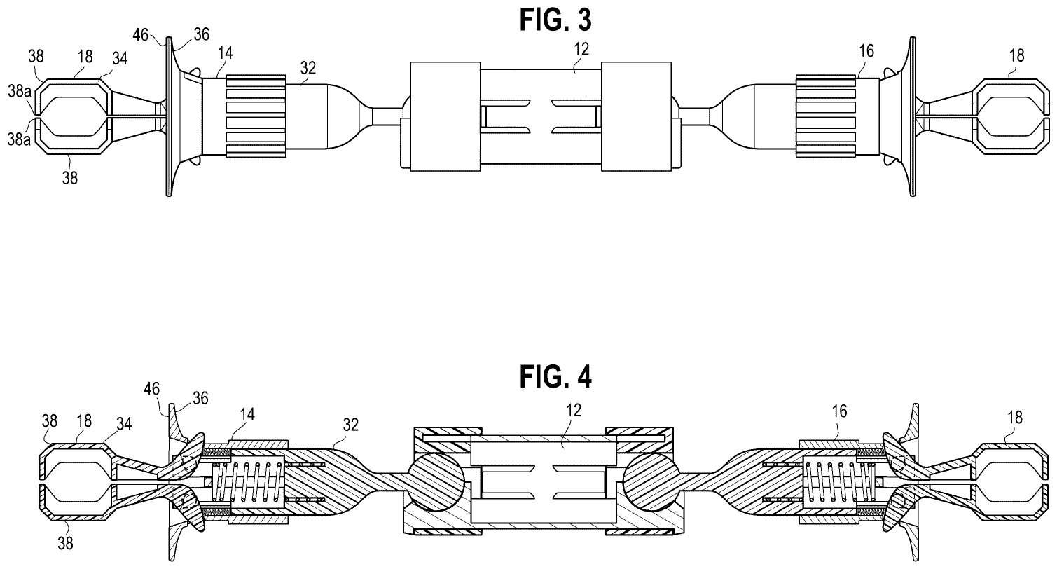

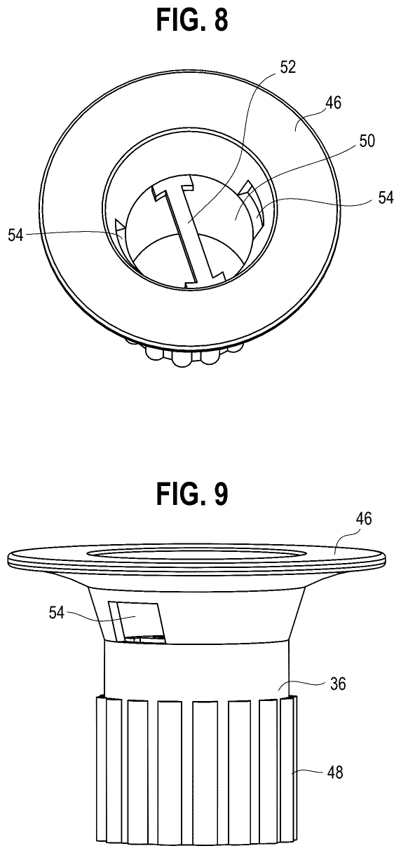

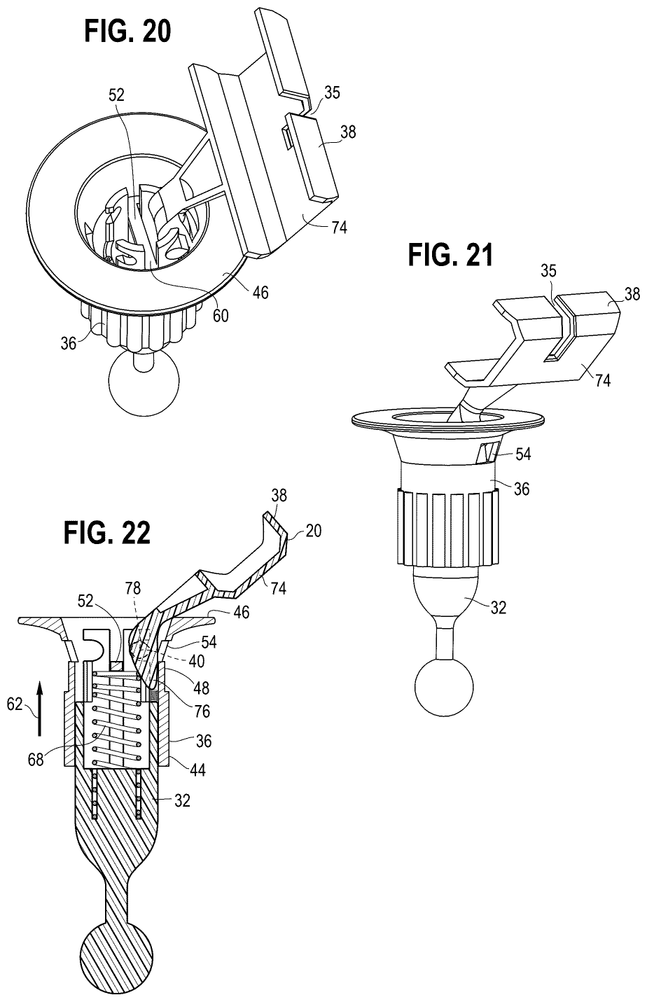

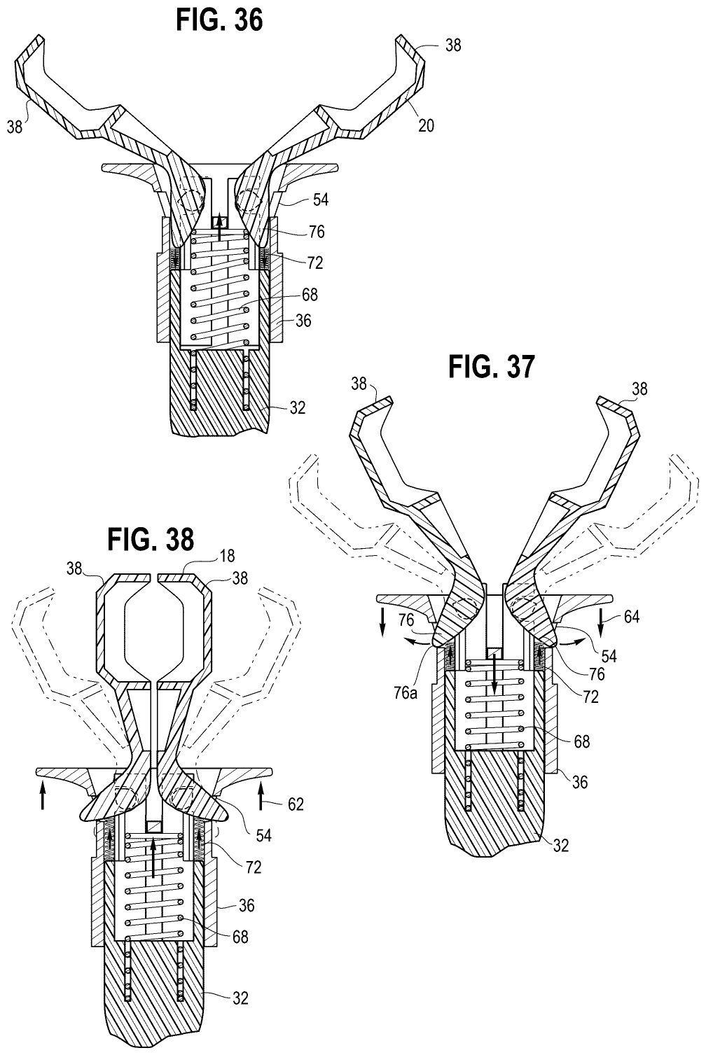

Referring to FIGS. 3-6, 8-22, and 33-38, the coupling device will be discussed in greater detail below. In some embodiments, the first and the second coupling devices 14 and 16 are the same, and for the sake of simplicity, one of the first and the second coupling devices 14 and 16 may be used to describe the specific features, which will be understood also applicable to the other one of the first and the second coupling devices 14 and 16. As shown, the first coupling device 14 may include an inner shaft 32, a claw assembly 34, and an outer cap 36. Referring to FIGS. 8 and 9, the outer cap 36 includes a side wall 48, an inner lumen 50 enclosed by the side wall 48, and an inner member 52 disposed in the inner lumen 50. The side wall 48 includes a distal surface 46 and at least one opening 54 (e.g., two openings 54, as shown in FIG. 8). In some embodiments, as shown in FIG. 8, the side wall 48 includes two openings 54 disposed substantially 180 degrees apart. When the claw assembly 34 (e.g., with two claws 38), the inner shaft 32, and the outer cap 36 are coupled together, as discussed below, the inner member 52 is configured to be placed in the gap between the two claws 38 of the claw assembly 34 so that no interference between the inner member 52 and the claw assembly 34 occurs.

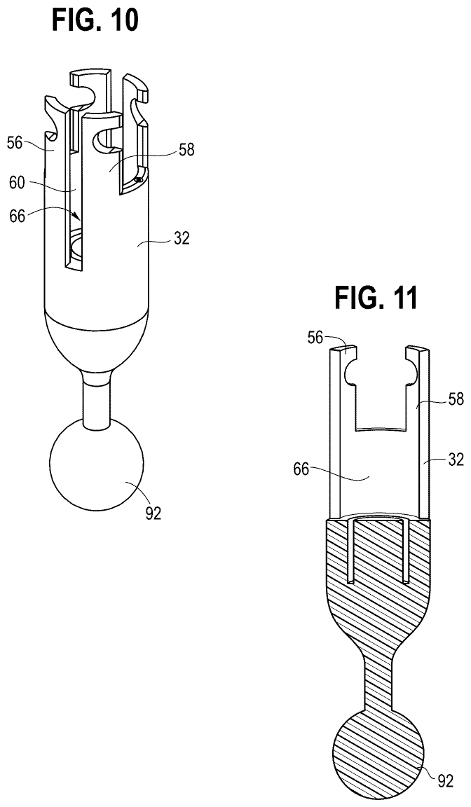

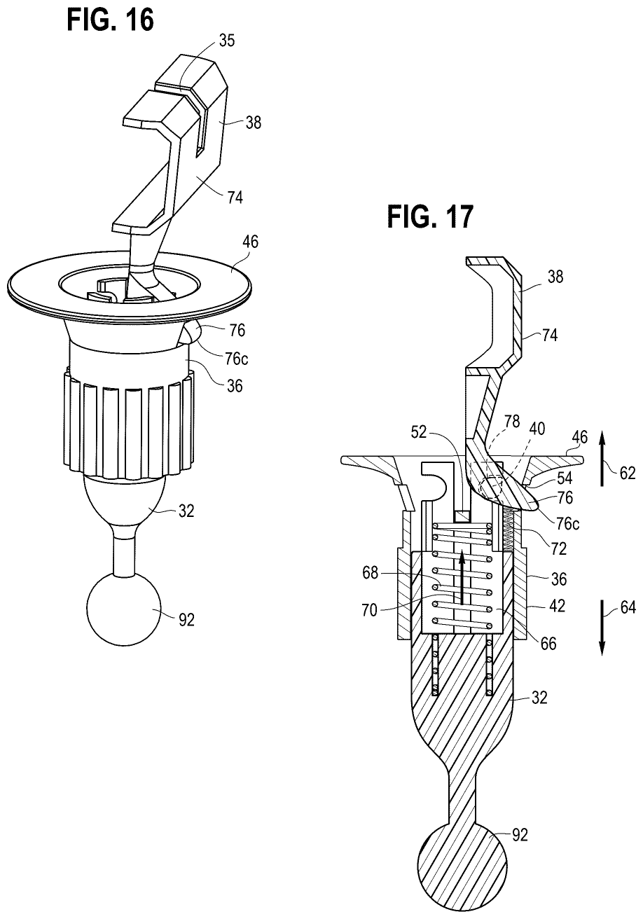

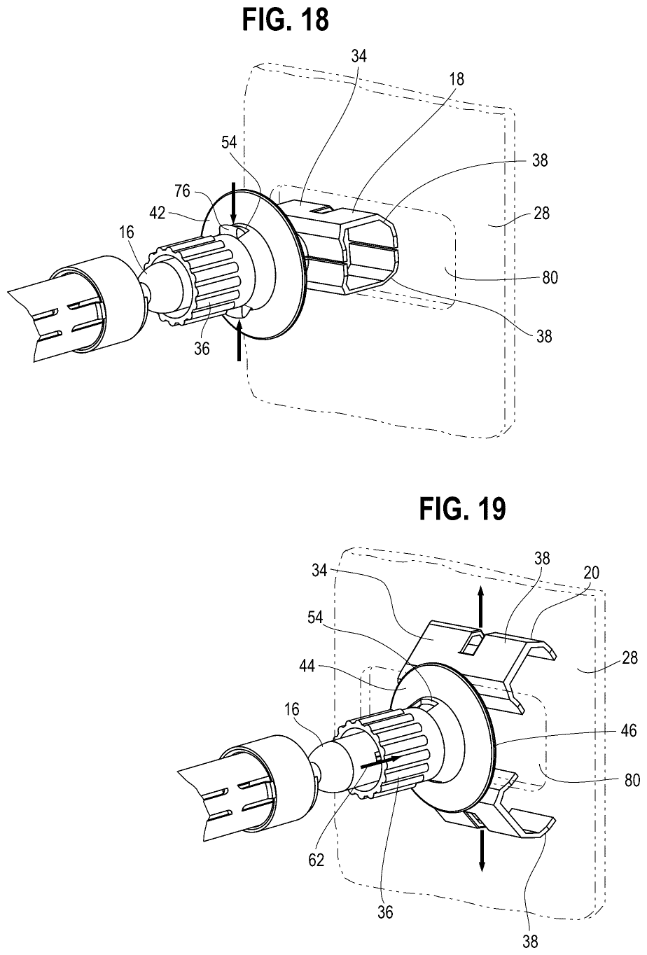

Referring to FIGS. 10 and 11, the inner shaft 32 includes a first side wall 56, a second side wall 58, and a space 60 disposed between the first side wall 56 and the second side wall 58. Referring to FIGS. 16-22, when the inner shaft 32 and the outer cap 36 are coupled together, at least a portion of the inner shaft 32 extends into the inner lumen 50 of the outer cap 36, where the space 60 is configured to allow the inner member 52 to move distally 62 or proximally 64 in the space 60 when the outer cap 36 moves distally 62 or proximally 64. The outer cap 36 is movably coupled to the inner shaft 32, where the outer cap 36 is movable between a proximal position 42 (e.g., as shown in FIGS. 17 and 18) and a distal position 44 (e.g., as shown in FIGS. 19 and 22). Referring to FIGS. 10, 11 and 17, the first and the second side walls 56 and 58 collectively form a shaft cavity 66 therebetween. The inner shaft 32 supports a first biasing member 68 in the shaft cavity 66. As shown in FIG. 17, when the outer cap 36 is in the proximal position 42, the first biasing member 68 is in a compressed state, applying a distal force 70 on the inner member 52. In some embodiments, the inner shaft 32 also includes a ball joint 92 for connection with other devices, as discussed in detail below.

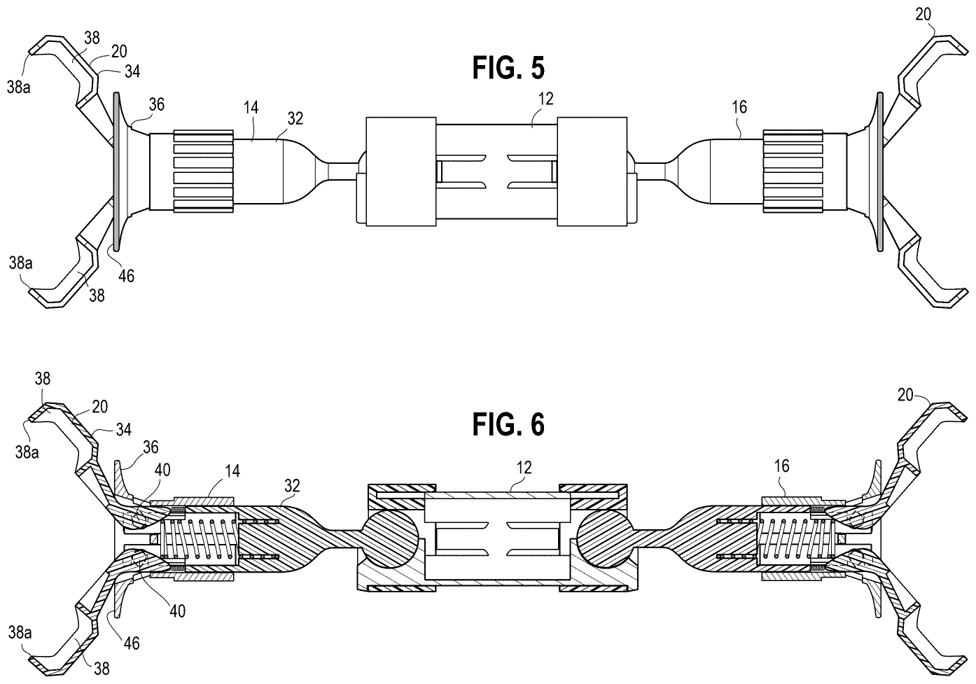

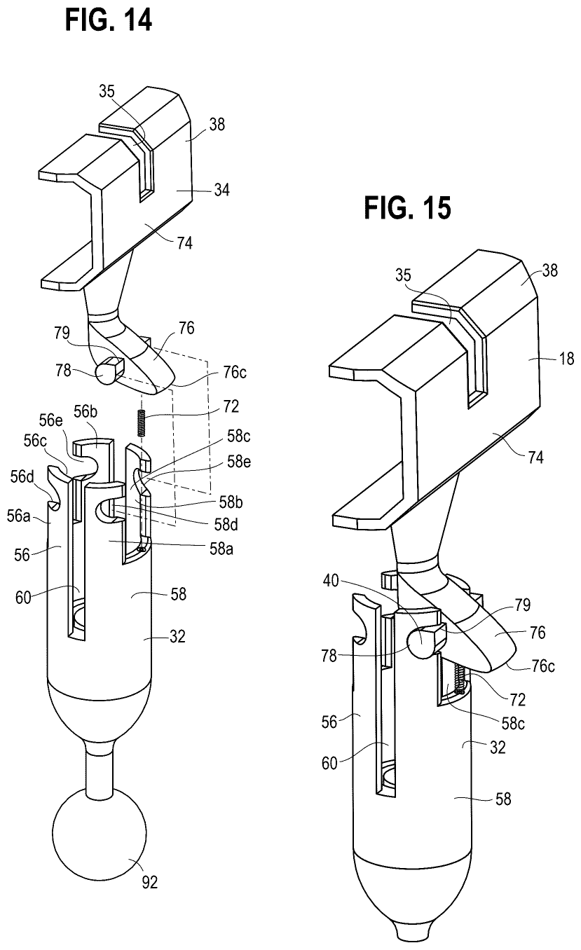

Referring to FIGS. 14-17 and 20-22, the claw assembly 34 is pivotably coupled to the inner shaft 32, where the claw assembly 34 includes at least one claw 38 pivotable around a claw pivot point 40 between a first/closed state 18 (e.g., as shown in FIG. 17) and a second/open state 20 (e.g., as shown in FIG. 22). In some embodiments, as shown in FIGS. 3-6, 18, and 19, the claw assembly 34 comprises at least two claws 38, where each claw 38 is pivotable around a respective pivot point 40 to pivot the at least two claws 38 to the first/closed state 18 (e.g., as shown in FIGS. 3 and 4), where the distal ends 38a of the at least two claws 38 are brought together, and to the second/open state 20 (e.g., as shown in FIGS. 5 and 6), where the distal ends 38a of the at least two claws 38 are spread apart. For the sake of simplicity, the coupling mechanism of one claw 38, the inner shaft 32, and the outer cap 36 will be described in detail, which will be understood also applicable to the other claw 38.

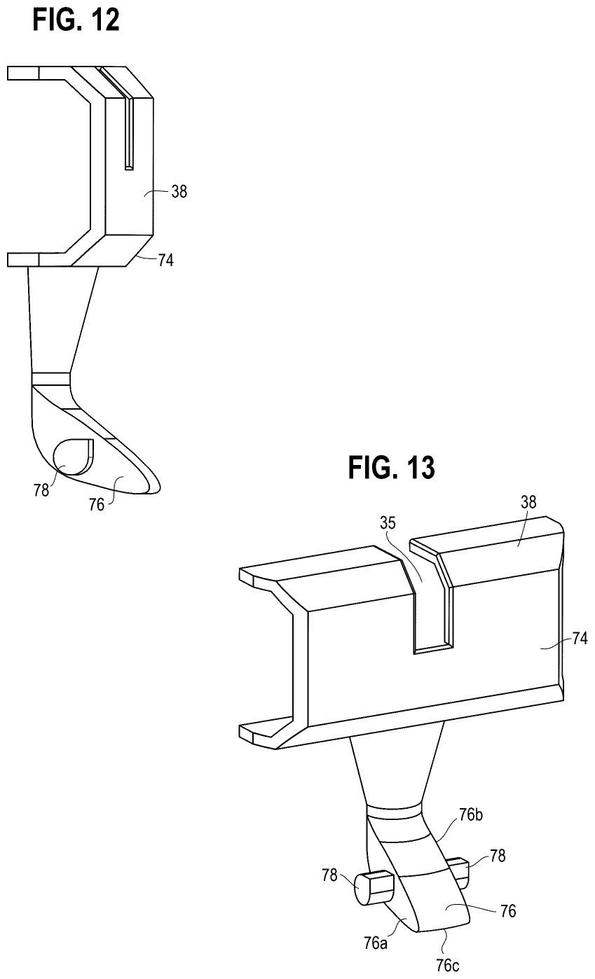

Referring to FIGS. 12-15, in some embodiments, the claw 38 includes an arm portion 74, a button portion 76, and at least one pivot portion 78 extending out of the button portion 76. In some embodiments, an arm cutout 35 is disposed in the middle of the claw 38, which is configured so that the claw 38 could grip metal wire on utility shelves, as needed. Previously, if metal wire was spaced tightly, the claw could not grip the shelf. In some embodiments, a rubber coating may be added to the inside of the claw 38 for additional grip.

As shown in FIG. 13, the claw 38 includes two pivot portions 78 extending out of the button portion 76 from opposite side surfaces 76a and 76b of the button portion 76. Referring to FIGS. 14 and 15, the first side wall 56 of the inner shaft 32 includes a first portion 56a, a second portion 56b, and a first side space 56c disposed between the first portion 56a and the second portion 56b. The second side wall 58 includes a third portion 58a, a fourth portion 58b, and a second side space 58c disposed between the third portion 58a and the fourth portion 58b. Each of the first, second, third, and fourth portions 56a, 56b, 58a, and 58b includes a cutout 56d, 56e, 58d, and 58e configured for pivotably coupling to a respective pivot portion 78 of a claw 38. In some embodiments, the pivot portion 78 of the claw 38 that sits inside the cutout of the inner shaft 32 has a circular configuration with a corner 79 to prevent over-rotation via interference between straight portions of the corner 79 and inner surfaces of the cutouts 56d, 56e, 58d, and 58e thereby limiting the amount of rotation.

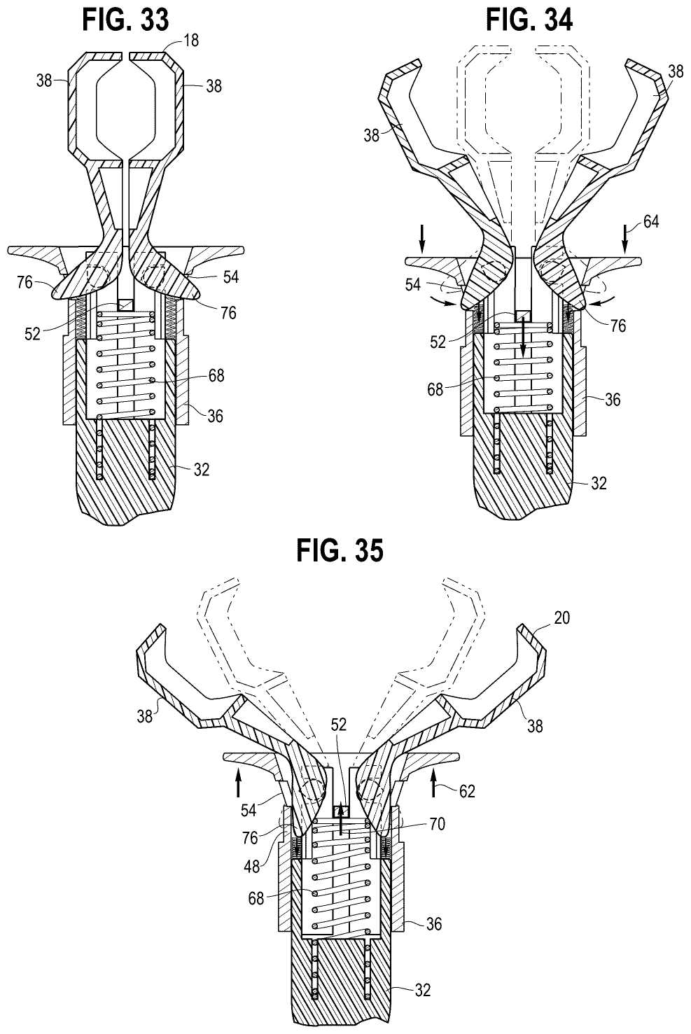

Referring to FIGS. 16-22 and 33-35, the at least one opening 54 of the outer cap 36 is configured to allow the button portion 76 of the at least one claw 38 to at least partially extend through the at least one opening 54 when the claw assembly 34 is in the first/closed state 18. The button portion 76 of the at least one claw 38 is configured to be pressed inward through the at least one opening 54 such that the button portion 76 pivots out of the at least one opening 54 (and into the lumen 50 of the outer cap 36). Once the button portion 76 is moved fully inside the outer cap 36, the outer cap 36 will be moved distally 62 by the first biasing member 68 applying a distal force 70 on the inner member 52 of the outer cap 36. The outer cap 36 will be moved distally 62 until a portion of the side wall 48 is flush with the button portion 76 of the at least one claw 38 in the open state 20 (e.g., as shown in FIGS. 22 and 35).

Referring to FIGS. 14, 15, 17, and 36-38, the inner shaft 32 also supports at least one second biasing member 72 in the second side space 58c (and/or in the first side space 56c, although not shown), where the at least one second biasing member 72 is configured to bias the at least one claw 38 toward the first/closed state 18. When the at least one claw 38 is in the open state 20, a user may pull the outer cap 36 proximally 64 such that the at least one opening 54 on the outer cap 36 is moved to be in registry with a tip 76c of the button portion 76 of the at least one claw 38. Then as the outer cap 36 continues to move proximally 64, the least one second biasing member 72 urges the button portion 76 of the at least one claw 38 to move distally 62 and out of the opening 54 of the outer cap 36, and also urges the at least one claw 38 to rotate back (e.g., in the counter-clockwise direction) to the closed state 18.

As shown in FIGS. 18 and 19, the claw assembly 34 extends distal to the outer cap 36, where the outer cap 36 is configured such that when the outer cap 36 is in the proximal position 42, the claw assembly 34 is in the first/closed state 18 (e.g., as shown in FIG. 18), and when the outer cap 36 is in the distal position 44, the claw assembly 34 is in the second/open state 20 (e.g., as shown in FIG. 19). When the claw assembly 34 is in the first/closed state 18, the claw assembly 34 is configured to receive a first material 24 (e.g., a portion of a wire shelf, as shown in FIG. 2) within the claw assembly 34 to couple the first material 24 to the first coupling device 14, and when the claw assembly 34 is in the second/open state 20, the claw assembly 34 and a distal surface 46 of the outer cap 36 are configured to receive a second material 28 (e.g., sidewalls around an opening 80 in a big tote through which the claw 38 is inserted) therebetween to couple the second material 28 to the second coupling device 16.

As shown in FIGS. 1 and 19, when the claw assembly 34 is in the second/open state 20, the claw assembly 34 and the distal surface 46 of the outer cap 36 are configured to pinch the second material 28 therebetween to couple the second material 28 (e.g., an utility cart wall) to the second coupling device 16, where the distal surface 46 of the outer cap 36 is configured such that the distal surface 46 will flush against the second material 28 to make a secure connection. The claw assembly 34 is also configured to release the second material 28 when the claw assembly is in the first/closed state 18.

A method of operating the second coupling device 16 will be described in detail below. Referring to FIGS. 1, 18 and 19, to couple the second coupling device 16 to the second device 30, a user may insert the claw assembly 34 (in the closed state 18) into the opening 80 on a surface 28 (e.g., the second material 28) of the second device 30. Then the user may press the at least one button portion 76 of the claw assembly 34 (e.g., two button portions 76 of the two claws 38, as shown in FIG. 18) inward such that the at least one button portion 76 is moved outside of the at least one opening 54 on the side wall 48 of the outer cap 36, such that the outer cap 36 is moved upward/distally 62 by the first biasing member 68 of the inner shaft 32, and the claw assembly 34 is moved from the closed state 18 to an open state 20.

When the claw assembly 34 is in the open state 20, a portion of the surface 28 is received between the claw assembly 34 and a distal surface 46 of the outer cap 36 such that the claw assembly 34 and the outer cap 36 are secured onto the surface 28. This allows the claw assembly 34 to be locked inside the second device 30 (e.g., a cart). Then the user may move the second coupling device 16 and the second device 30 together. To release the second device 30 from the second coupling device 16, the user may pull the outer cap 36 proximally 64 to allow the at least one button portion 76 of the claw assembly 34 (e.g., two button portions 76 of the two claws 38, as shown in FIG. 18) to extend through the at least one opening 54 of the outer cap 36 until the claw assembly 34 returns to the closed state 18 (as discussed above with respect to FIGS. 36-38). Then the user may pull the second coupling device 16 out of the opening 80, such that the second device 30 is released from the second coupling device 16.

In addition, referring to FIG. 2 and the method discussed above regarding opening and closing the claw assembly 34, it will be understood that a user may couple the first coupling device 14 to the first device 26 by moving the claw assembly 34 from the open state 20 to the closed state 18 after the first material 24 is received within/between the two claws 38 of the claw assembly 34.

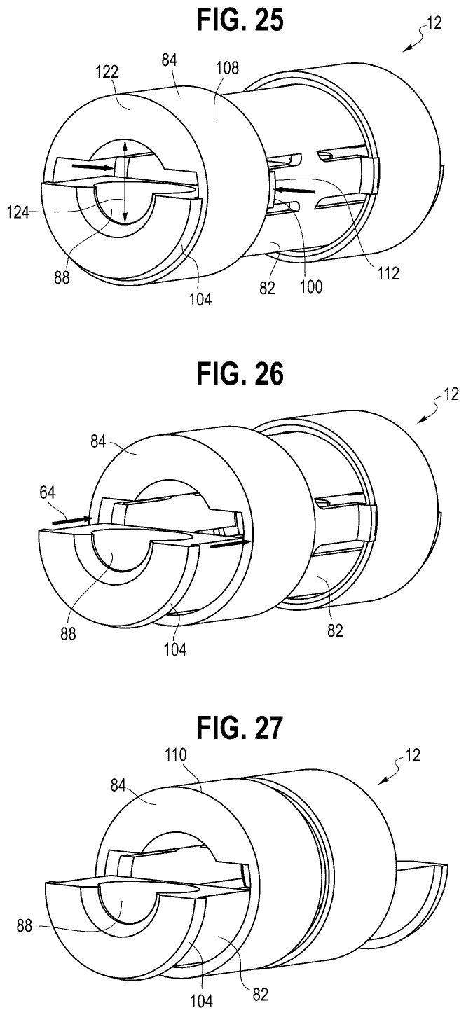

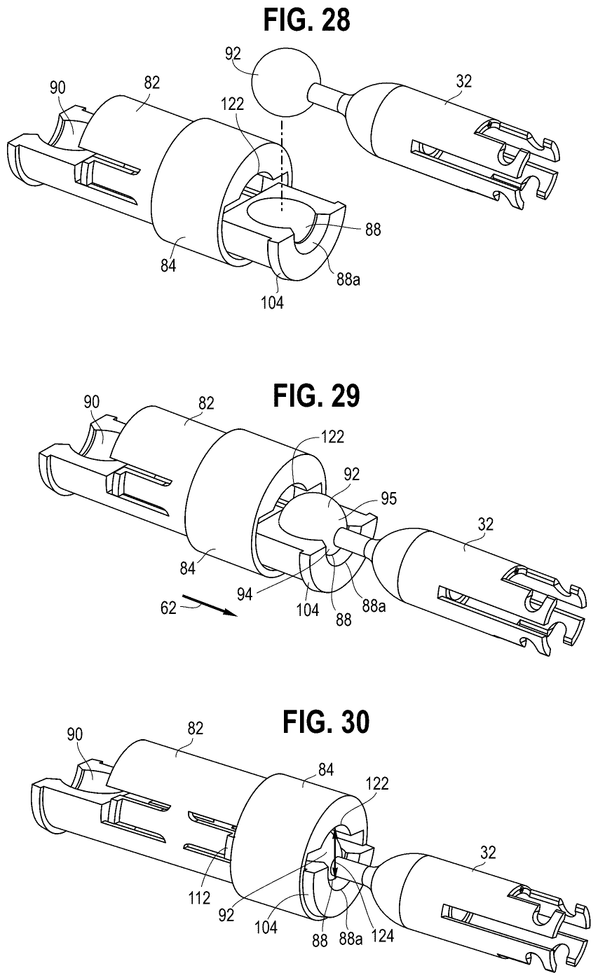

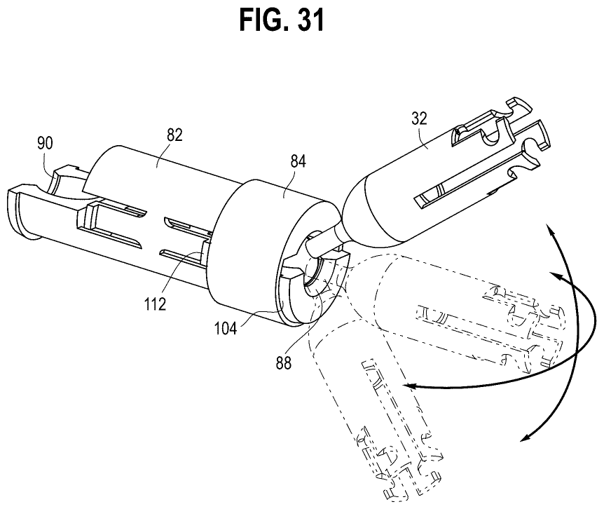

Referring to FIGS. 23-32, an embodiment of a connector assembly 12 will be discussed. The connector assembly 12 includes a connector shaft 82 and an outer connector cap 84. The outer connector cap 84 has a generally tubular configuration and is movably coupled outside of the connector shaft 82 (e.g., moveable along a length of the connector shaft 82). The connector shaft 82 has a generally tubular configuration with an inner lumen 86. The connector shaft 82 also includes at least one socket configured to receive a first part 94 of a ball joint 92 (e.g., the ball joint 92 of an inner shaft 32, as shown in FIGS. 28-30).

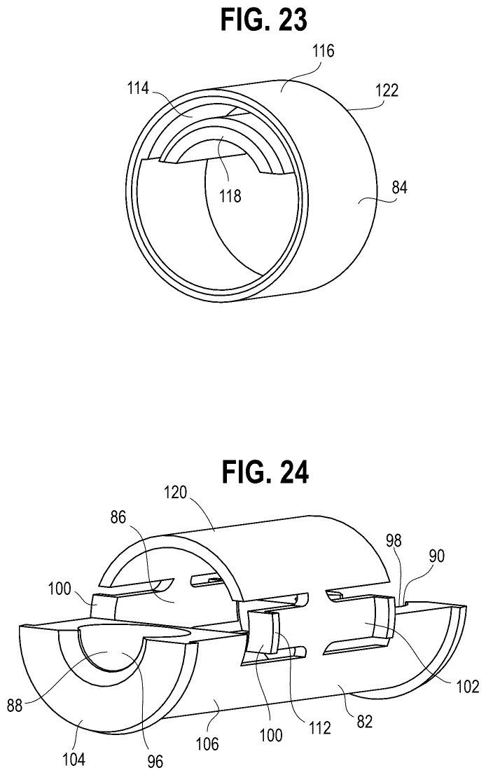

In some embodiments, as shown in FIGS. 24, and 28-30, the connector shaft 82 includes a first socket 88 and a second socket 90 with a similar configuration. The first and the second sockets 88 and 90 are disposed on the opposite ends of the connector shaft 82, which allows for quick attachment and release of two inner shafts 32 (e.g., inner shafts 32 of the first and the second coupling devices 14 and 16, as shown in FIGS. 3-6). For the sake of simplicity, one of the first or the second socket 88/90 may be specifically discussed for certain specific features, which will be understood also applicable to the other socket.

As shown in FIG. 24, the first socket 88 includes a first curved concave portion 96 and the second socket 90 includes a second curved concave portion 98. The connector shaft 82 includes at least one (e.g., two) first knob 100 disposed close to the first socket 88, and at least one (e.g., two) second knob 102 disposed close to the second socket 90. The first and the second knobs 100 and 102 each may have a similar configuration, and thus one of them may be specifically describe below, which will be understood also applicable to other knobs. Each of the first and the second knobs 100 and 102 are cantilevered with respect to a connector side wall 106 of the connector shaft 82.

Referring to FIGS. 25-30, the outer connector cap 84 is configured to be movable between a fixed position 108 (e.g., as shown in FIGS. 25 and 30) and a released position 110 (e.g., as shown in FIGS. 27-29). As shown, the first knob 100 includes a first knob flange 112 and the first socket 88 includes a first socket flange 104. When the outer connector cap 84 is in the fixed position 108, the outer connector cap 84 is disposed between the first knob flange 112 and the first socket flange 104, and is prevented from moving along a length of the connector shaft 82 by the first knob flange 112 and the first socket flange 104.

Referring to FIGS. 25-27, in some embodiments, the first knobs 100 are configured to be pressed down (e.g., towards the inner lumen 86 of the connector shaft 82) to allow the outer connector cap 84 to move from the fixed position 108 to the released position 110. As shown in FIG. 23, in some embodiments, the outer connector cap 84 includes a sliding cavity 114 formed by a portion of the side wall 116 of the outer connector cap 84 and an inner curved portion 118. As shown in FIGS. 25-27, the sliding cavity 114 is configured to allow a side portion 120 of the connector shaft 82 to move within the sliding cavity 114 when the outer connector cap 84 moves between the fixed position 108 and the released position 110. When the first knobs 100 are pressed down, the outer connector cap 84 may be moved proximally 64 until the side portion 120 of the connector shaft 82 reaches a bottom part 122 of the sliding cavity 114.

As shown in FIGS. 28-31, when the outer connector cap 84 is in the fixed position 108, the outer connector cap 84 is configured to receive a second part 95 of a ball joint 92 to lock the ball joint 92 within the first socket 88 between the outer connector cap 84 and the first socket 88. As shown, the first distance 124 between a bottom part 88a of the first socket 88 and a bottom part 122 of the sliding cavity 114 is smaller than a diameter of the ball joint 92, such that the ball joint 92 is locked between the first socket 88 and the outer connector cap 84, while allowing pivotable movements of the inner shaft 32 around a pivot point provided by the ball joint 92. When the outer connector cap 84 is in the released position 110, the first part 94 of the ball joint 92 can be released from the first socket 88.

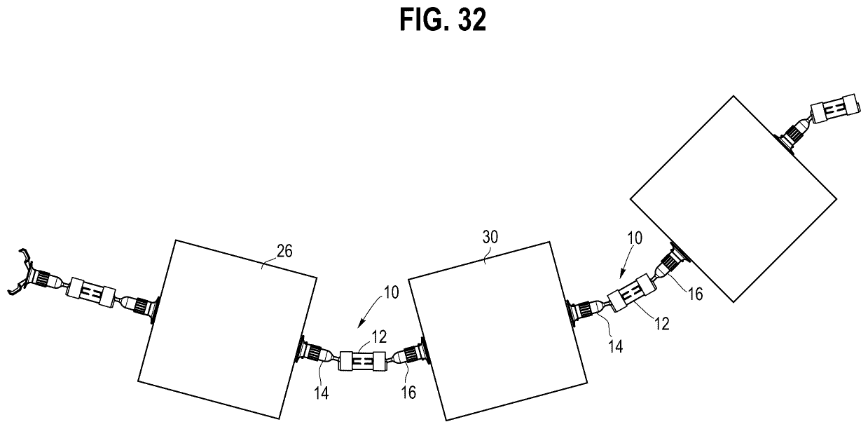

As show in FIGS. 1, 3-7, and 32, the connector assembly 12 may be used to couple the first coupling device 14 and the second coupling device 16 together via the respective ball joints 92 of the respective inner shafts 32. As shown in FIG. 32, due to the connection between the connector assembly 12 and the ball joints 92, a plurality of devices may be coupled and moved together by one or more coupling assemblies 10, while the plurality of devices are moved along a curved path.

To couple the first coupling device 14 and the connector assembly 12 together, a user may press the at least one knob (e.g., the first knobs 100) down/inward and then move the outer connector cap 84 proximally 64 away from the first socket 88. After the outer connector cap 84 is moved from the fixed position 108 to the released position 110, a user may place the ball joint 92 in the first socket 88 (while the outer connector cap 84 is away from the first socket 88). Then, the user may move the outer connector cap 84 distally 62/towards the first socket 88 and lock the ball joint 92 in the first socket 88 between the outer connector cap 84 and the first socket 88.

To release the ball joint 92 from the first socket 88, a user may move the outer connector cap 84 proximally 64 away from the first socket 88. After the outer connector cap 84 is moved from the fixed position 108 to the released position 110, the user may release/remove the ball joint 92 from the first socket 88.

The subject matter of the disclosure may also relate, among others, to the following aspects:

A first aspect relates to a coupling device, comprising: an inner shaft; a claw assembly pivotably coupled to the inner shaft, the claw assembly comprising at least one claw pivotable around a claw pivot point between a first state and a second state; and an outer cap movably coupled to the inner shaft, wherein the outer cap is movable between a proximal position and a distal position, wherein the claw assembly extends distal to the outer cap, wherein the outer cap is configured such that when the outer cap is in the proximal position, the claw assembly is in the first state, and when the outer cap is in the distal position, the claw assembly is in the second state, wherein when the claw assembly is in the first state, the claw assembly is configured to receive a first material within the claw assembly to couple the first material to the coupling device, and wherein when the claw assembly is in the second state, the claw assembly and a distal surface of the outer cap are configured to receive a second material therebetween to couple the second material to the coupling device.

A second aspect relates to the coupling device of aspect 1, wherein when the claw assembly is in the second state, the claw assembly and the distal surface of the outer cap are configured to pinch the second material therebetween to couple the second material to the coupling device.

A third aspect relates to the coupling device of any preceding aspect, wherein the claw assembly is configured to release the second material when the claw assembly is in the first state.

A fourth aspect relates to the coupling device of any preceding aspect, wherein the claw assembly comprises at least two claws, each claw pivotable around a respective pivot point to pivot the at least two claws to the first state wherein distal ends of the at least two claws are brought together, and to the second state wherein the distal ends of the at least two claws are spread apart.

A fifth aspect relates to the coupling device of any preceding aspect, wherein the coupling device is configured to connect to the first or second material such that the first or second material and the coupling device move together.

A sixth aspect relates to the coupling device of any preceding aspect, wherein the outer cap includes a side wall, an inner lumen enclosed by the side wall, and an inner member disposed in the inner lumen, wherein the inner shaft supports a first biasing member, and at least a portion of the inner shaft extends into the inner lumen of the outer cap, and wherein when the outer cap is in the proximal position, the first biasing member is in a compressed state, applying a distal force on the inner member.

A seventh aspect relates to the coupling device of any preceding aspect, wherein the inner shaft includes a first side wall, a second side wall, and a space disposed between the first side wall and the second side wall, and wherein the space is configured to allow the inner member to move distally or proximally in the space when the outer cap moves distally or proximally.

An eighth aspect relates to the coupling device of any preceding aspect, wherein the at least one claw has a button portion, wherein a side wall of the outer cap includes at least one opening configured to allow the button portion of the at least one claw to at least partially extend through the at least one opening when the claw assembly is in the first state.

A ninth aspect relates to the coupling device of any preceding aspect, wherein the button portion of the at least one claw is configured to be pressed inward through the at least one opening such that the button portion pivots out of the at least one opening such that the outer cap is moved distally by the first biasing member.

A tenth aspect relates to the coupling device of any preceding aspect, wherein the inner shaft supports at least one second biasing member, and wherein the at least one second biasing member is configured to bias the at least one claw toward the first state.

An eleventh aspect relates to a method of operating a coupling device, the coupling device comprising an inner shaft, a claw assembly pivotably coupled to the inner shaft, and an outer cap movably coupled to the inner shaft, wherein the outer cap includes at least one opening, the claw assembly includes at least one button portion, and when the claw assembly is in a closed state, the at least one button portion at least partially extends through the at least one opening, the method comprising: pressing the at least one button portion inward such that the at least one button portion is moved outside of the at least one opening, such that the outer cap is moved upward by the inner shaft and the claw assembly is moved from the closed state to an open state.

A twelfth aspect relates to the method of aspect 11, further comprising inserting the claw assembly into an opening in a surface before pressing the at least one button portion, such that when the claw assembly is in the open state, a portion of the surface is received between the claw assembly and a distal surface of the outer cap such that the claw assembly and the outer cap are secured onto the surface.

A thirteenth aspect relates to the method of any one of aspects 11 or 12, further comprising pulling the outer cap proximally to allow the at least one button portion of the claw assembly to extend through the at least one opening of the outer cap until the claw assembly returns to the closed state.

A fourteenth aspect relates to a connector assembly, comprising: a connector shaft including a socket configured to receive a first part of a ball joint; and an outer connector cap movably coupled to the connector shaft, wherein the outer connector cap is configured to be movable between a fixed position and a released position, wherein when the outer connector cap is in the fixed position, the outer connector cap is configured to receive a second part of a ball joint to lock the ball joint within the socket between the outer connector cap and the socket, and wherein when the outer connector cap is in the released position, the first part of the ball joint can be released from the socket.

A fifteenth aspect relates to the connector assembly of aspect 14, wherein the connector shaft includes at least one knob configured to be pressed down to allow the outer connector cap to move from the fixed position to the released position.

A sixteenth aspect relates to the connector assembly of any one of aspects 14 or 15, wherein the at least one knob includes a knob flange and the socket includes a socket flange, and wherein when the outer connector cap is in the fixed position, the outer connector cap is disposed between the knob flange and the socket flange, and is prevented from moving along a length of the connector shaft by the knob flange and the socket flange.

A seventeenth aspect relates to the connector assembly of any one of aspects 14 to 16, wherein the outer connector cap includes a sliding cavity configured to allow a side portion of the connector shaft to move within the sliding cavity when the outer connector cap moves between the fixed position and the released position.

An eighteenth aspect relates to the connector assembly of any one of aspects 14 to 17, wherein the connector shaft includes at least one knob configured to be pressed down to allow the outer connector cap to move distally until the side portion of the connector shaft reaches a bottom part of the sliding cavity.

A nineteenth aspect relates to the connector assembly of any one of aspects 14 to 18, wherein a distance between a bottom part of the socket and a bottom part of the sliding cavity is smaller than a diameter of the ball joint.

A twentieth aspect relates to a method of operating a connector assembly, the connector assembly comprising a connector shaft including a socket configured to receive a first part of a ball joint, and an outer connector cap movably coupled to the connector shaft, wherein the outer connector cap is configured to be movable between a fixed position and a released position, the method comprising: placing a ball joint in the socket while the outer connector cap is away from the socket; moving the outer connector cap towards the socket and locking the ball joint in the socket between the outer connector cap and the socket; moving the outer connector cap proximally away from the socket; and releasing the ball joint from the socket.

A twenty-first aspect relates to the method of aspect 20, wherein the connector shaft includes at least one knob, and wherein when the outer connector cap is in the fixed position, the outer connector cap is disposed between a knob flange of the at least one knob and a socket flange of the socket, the method further comprising: pressing the at least one knob down; and moving the outer connector cap proximally away from the socket before placing the ball joint in the socket or releasing the ball joint from the socket.

A twenty-second aspect relates to the method of any one of aspects 20 or 21, further comprising: moving the outer connector cap distally towards the socket.

Those of skill in the art will appreciate that embodiments not expressly illustrated herein may be practiced within the scope of the claims, including that features described herein for different embodiments may be combined with each other and/or with currently-known or future-developed technologies while remaining within the scope of the claims. Although specific terms are employed herein, they are used in a generic and descriptive sense only and not for purposes of limitation unless specifically defined by context, usage, or other explicit designation. It is therefore intended that the foregoing detailed description be regarded as illustrative rather than limiting. And, it should be understood that the following claims, including all equivalents, are intended to define the spirit and scope of this invention. Furthermore, the advantages described above are not necessarily the only advantages of the invention, and it is not necessarily expected that all of the described advantages will be achieved with every embodiment. In the event of any inconsistent disclosure or definition from the present application conflicting with any document incorporated by reference, the disclosure or definition herein shall be deemed to prevail.

1. A coupling device, comprising:
an inner shaft;
a claw assembly pivotably coupled to the inner shaft, the claw assembly comprising at least one claw pivotable around a claw pivot point between a first state and a second state; and
an outer cap movably coupled to the inner shaft, wherein the outer cap is movable between a proximal position and a distal position, wherein the claw assembly extends distal to the outer cap,
wherein the outer cap is configured such that when the outer cap is in the proximal position, the claw assembly is in the first state, and when the outer cap is in the distal position, the claw assembly is in the second state,
wherein when the claw assembly is in the first state, the claw assembly is configured to receive a first material within the claw assembly to couple the first material to the coupling device, and
wherein when the claw assembly is in the second state, the claw assembly and a distal surface of the outer cap are configured to receive a second material therebetween to couple the second material to the coupling device.

2. The coupling device of claim 1, wherein when the claw assembly is in the second state, the claw assembly and the distal surface of the outer cap are configured to pinch the second material therebetween to couple the second material to the coupling device.

3. The coupling device of claim 1, wherein the claw assembly is configured to release the second material when the claw assembly is in the first state.

4. The coupling device of claim 1, wherein the claw assembly comprises at least two claws, each claw pivotable around a respective pivot point to pivot the at least two claws to the first state wherein distal ends of the at least two claws are brought together, and to the second state wherein the distal ends of the at least two claws are spread apart.

5. The coupling device of claim 1, wherein the coupling device is configured to connect to the first or second material such that the first or second material and the coupling device move together.

6. The coupling device of claim 1, wherein the outer cap includes a side wall, an inner lumen enclosed by the side wall, and an inner member disposed in the inner lumen, wherein the inner shaft supports a first biasing member, and at least a portion of the inner shaft extends into the inner lumen of the outer cap, and wherein when the outer cap is in the proximal position, the first biasing member is in a compressed state, applying a distal force on the inner member.

7. The coupling device of claim 6, wherein the inner shaft includes a first side wall, a second side wall, and a space disposed between the first side wall and the second side wall, and wherein the space is configured to allow the inner member to move distally or proximally in the space when the outer cap moves distally or proximally.

8. The coupling device of claim 1, wherein the at least one claw has a button portion, wherein a side wall of the outer cap includes at least one opening configured to allow the button portion of the at least one claw to at least partially extend through the at least one opening when the claw assembly is in the first state.

9. The coupling device of claim 8, wherein the button portion of the at least one claw is configured to be pressed inward through the at least one opening such that the button portion pivots out of the at least one opening such that the outer cap is moved distally by the first biasing member.

10. The coupling device of claim 8, wherein the inner shaft supports at least one second biasing member, and wherein the at least one second biasing member is configured to bias the at least one claw toward the first state.

11. A method of operating a coupling device, the coupling device comprising an inner shaft, a claw assembly pivotably coupled to the inner shaft, and an outer cap movably coupled to the inner shaft, wherein the outer cap includes at least one opening, the claw assembly includes at least one button portion, and when the claw assembly is in a closed state, the at least one button portion at least partially extends through the at least one opening, the method comprising:
pressing the at least one button portion inward such that the at least one button portion is moved outside of the at least one opening, such that the outer cap is moved upward by the inner shaft and the claw assembly is moved from the closed state to an open state.

12. The method of claim 11, further comprising inserting the claw assembly into an opening in a surface before pressing the at least one button portion, such that when the claw assembly is in the open state, a portion of the surface is received between the claw assembly and a distal surface of the outer cap such that the claw assembly and the outer cap are secured onto the surface.

13. The method of claim 11, further comprising pulling the outer cap proximally to allow the at least one button portion of the claw assembly to extend through the at least one opening of the outer cap until the claw assembly returns to the closed state.

14. A connector assembly, comprising:
a connector shaft including a socket configured to receive a first part of a ball joint; and
an outer connector cap movably coupled to the connector shaft, wherein the outer connector cap is configured to be movable between a fixed position and a released position,
wherein when the outer connector cap is in the fixed position, the outer connector cap is configured to receive a second part of a ball joint to lock the ball joint within the socket between the outer connector cap and the socket, and
wherein when the outer connector cap is in the released position, the first part of the ball joint can be released from the socket.

15. The connector assembly of claim 14, wherein the connector shaft includes at least one knob configured to be pressed down to allow the outer connector cap to move from the fixed position to the released position.

16. The connector assembly of claim 15, wherein the at least one knob includes a knob flange and the socket includes a socket flange, and wherein when the outer connector cap is in the fixed position, the outer connector cap is disposed between the knob flange and the socket flange, and is prevented from moving along a length of the connector shaft by the knob flange and the socket flange.

17. The connector assembly of claim 14, wherein the outer connector cap includes a sliding cavity configured to allow a side portion of the connector shaft to move within the sliding cavity when the outer connector cap moves between the fixed position and the released position.

18. The connector assembly of claim 17, wherein the connector shaft includes at least one knob configured to be pressed down to allow the outer connector cap to move distally until the side portion of the connector shaft reaches a bottom part of the sliding cavity.

19. The connector assembly of claim 17, wherein a distance between a bottom part of the socket and a bottom part of the sliding cavity is smaller than a diameter of the ball joint.

20. A method of operating a connector assembly, the connector assembly comprising a connector shaft including a socket configured to receive a first part of a ball joint, and an outer connector cap movably coupled to the connector shaft, wherein the outer connector cap is configured to be movable between a fixed position and a released position, the method comprising:
placing a ball joint in the socket while the outer connector cap is away from the socket;
moving the outer connector cap towards the socket and locking the ball joint in the socket between the outer connector cap and the socket;
moving the outer connector cap proximally away from the socket; and
releasing the ball joint from the socket.

21. The method of claim 20, wherein the connector shaft includes at least one knob, and wherein when the outer connector cap is in the fixed position, the outer connector cap is disposed between a knob flange of the at least one knob and a socket flange of the socket, the method further comprising:
pressing the at least one knob down; and
moving the outer connector cap proximally away from the socket before placing the ball joint in the socket or releasing the ball joint from the socket.

22. The method of claim 21, further comprising: moving the outer connector cap distally towards the socket.
